(19) United States
(12) Patent Application Publication
(10) Pub. No.: US 2024/0248243 A1
(43) Pub. Date: Jul. 25, 2024

(54) POLARIZER AND DISPLAY

(71) Applicant: GUANGZHOU LUXVISIONS INNOVATION TECHNOLOGY LIMITED, Guangzhou (CN)

(72) Inventors: Yi-Chih Lai, Guangzhou (CN); Lee-Lin Tsai, Guangzhou (CN); Wei-Han Wu, Guangzhou (CN)

(73) Assignee: GUANGZHOU LUXVISIONS INNOVATION TECHNOLOGY LIMITED, Guangzhou (CN)

(21) Appl. No.: 18/384,135

(22) Filed: Oct. 26, 2023

(30) Foreign Application Priority Data
Jan. 19, 2023 (CN) 202310078809.5

(51) Int. Cl. G02B 5/30

(52) U.S. Cl. CPC G02B 5/305

(57) ABSTRACT

A polarizer includes a first polarization layer group. The first polarization layer group includes a first light-transmitting layer and a second light-transmitting layer. The first light-transmitting layer has a first X-direction refractive index and a first Y-direction refractive index. The second light-transmitting layer is superimposed on a top surface of the first light-transmitting layer. The second light-transmitting layer has a second X-direction refractive index and a second Y-direction refractive index. The first Y-direction refractive index is different from the second Y-direction refractive index, and the first X-direction refractive index is essentially the same as the second X-direction refractive index. The second light-transmitting layer has a first light-transmitting medium and a second light-transmitting medium arranged transversely, and a third refractive index of the first light-transmitting medium is different from a fourth refractive index of the second light-transmitting medium.

### CROSS-REFERENCE TO RELATED APPLICATION

This non-provisional application claims priority under 35 U.S.C. § 119(a) to Patent Application No. 202310078809.5 filed in China on Jan. 19, 2023, the entire contents of which are hereby incorporated by reference.

### BACKGROUND

### Technical Field

The present disclosure relates to a polarizer, and in particular to a polarizer that combines the advantages of a metal wire grid polarizer and a multi-layer film reflective polarizer.

### Related Art

The existing reflective polarizing film technology can be divided into a metal wire grid polarizer and a multi-layer film reflective polarizer. The metal wire grid polarizer has an excellent optical extinction ratio, but its absorption coefficientresults in poor light efficiency. The multi-layer film reflective polarizer has little difference in birefringence between two directions of the material, needs to stack hundreds of layers of films, and has poor TE and TM wave transmission coefficient and extinction ratio.

### SUMMARY

In view of the defects of the prior art, the present disclosure provides a polarizer, including a first polarization layer group. The first polarization layer group includes a first light-transmitting layer and a second light-transmitting layer. The first light-transmitting layer has a first X-direction refractive index and a first Y-direction refractive index. The second light-transmitting layer is superimposed on a top surface of the first light-transmitting layer. The second light-transmitting layer has a second X-direction refractive index and a second Y-direction refractive index. The first Y-direction refractive index is different from the second Y-direction refractive index, and the first X-direction refractive index is essentially the same as the second X-direction refractive index. The second light-transmitting layer has a first light-transmitting medium and a second light-transmitting medium arranged transversely, and a third refractive index of the first light-transmitting medium is different from a fourth refractive index of the second light-transmitting medium.

In some embodiments, the present disclosure provides a display, including a display body and a polarizer. The polarizer is arranged in the display body. The polarizer includes a first polarization layer group. The first polarization layer group includes a first light-transmitting layer and a second light-transmitting layer. The first light-transmitting layer has a first X-direction refractive index and a first Y-direction refractive index. The second light-transmitting layer is superimposed on a top surface of the first light-transmitting layer. The second light-transmitting layer has a second X-direction refractive index and a second Y-direction refractive index. The first Y-direction refractive index is different from the second Y-direction refractive index, and the first X-direction refractive index is essentially the same as the second X-direction refractive index. The second light-transmitting layer has a first light-transmitting medium and a second light-transmitting medium arranged transversely, and a third refractive index of the first light-transmitting medium is different from a fourth refractive index of the second light-transmitting medium.

According to the above description, the present disclosure has the following advantages: (1) The absorption of light by metals can be reduced. (2) Due to different refractive indices in X and Y directions, when multiple polarization layer groups are stacked mutually, the number of stack layers can be effectively reduced to reduce the overall thickness. (3) The extinction ratio is comparable to that of a metal wire grid polarizer and superior to that of a multi-layer film polarizer.

The present disclosure is described in detail below with reference to the drawings and specific embodiments which are not intended to limit the present disclosure.

### BRIEF DESCRIPTION OF THE DRAWINGS

FIG. 1 shows a schematic diagram of a first polarization layer group in some embodiments of the present disclosure;

FIG. 2 shows a schematic diagram of multiple first polarization layer groups being stacked and refractive indices in some embodiments of the present disclosure;

FIG. 3 shows a schematic diagram of an embodiment of a first polarization layer group in some embodiments of the present disclosure;

FIG. 4 shows a schematic diagram of another embodiment of a first polarization layer group in some embodiments of the present disclosure;

FIG. 5 shows a schematic diagram of a still another embodiment of a first polarization layer group in some embodiments of the present disclosure;

FIG. 6 shows an experimental data diagram of transmission coefficients of a TM wave and a TE wave after 3 first polarization layer groups are stacked mutually and 11 first polarization layer groups are stacked mutually in some embodiments of the present disclosure;

FIG. 7 shows an experimental data diagram of reflection coefficients of a TM wave and a TE wave after 3 first polarization layer groups are stacked mutually and 11 first polarization layer groups are stacked mutually in some embodiments of the present disclosure;

FIG. 8 shows an experimental data diagram of absorption coefficients of a TM wave and a TE wave after 3 first polarization layer groups are stacked mutually and 11 first polarization layer groups are stacked mutually in some embodiments of the present disclosure;

FIG. 9 shows an experimental data diagram of extinction ratios of a TM wave and a TE wave after 3 first polarization layer groups are stacked mutually and 11 first polarization layer groups are stacked mutually in some embodiments of the present disclosure;

FIG. 9A shows an enlarged diagram of experimental data of extinction ratios of a TM wave and a TE wave after 3 first polarization layer groups are stacked mutually in FIG. 9;

FIG. 10 shows an experimental data diagram of transmission coefficients of a TE wave and a TM wave at incident angles of 0° and 45° after 3 first polarization layer groups are stacked mutually in some embodiments of the present disclosure;

FIG. 11 shows an experimental data diagram of reflection coefficients of a TE wave and a TM wave at incident angles of 0° and 45° after 3 first polarization layer groups are stacked mutually in some embodiments of the present disclosure; and

FIG. 12 shows an experimental data diagram of absorption coefficients of a TE wave and a TM wave at incident angles of 0° and 45° after 3 first polarization layer groups are stacked mutually in some embodiments of the present disclosure.

### DETAILED DESCRIPTION

The structural principle and working principle of the present disclosure are specifically described below with reference to the drawings:

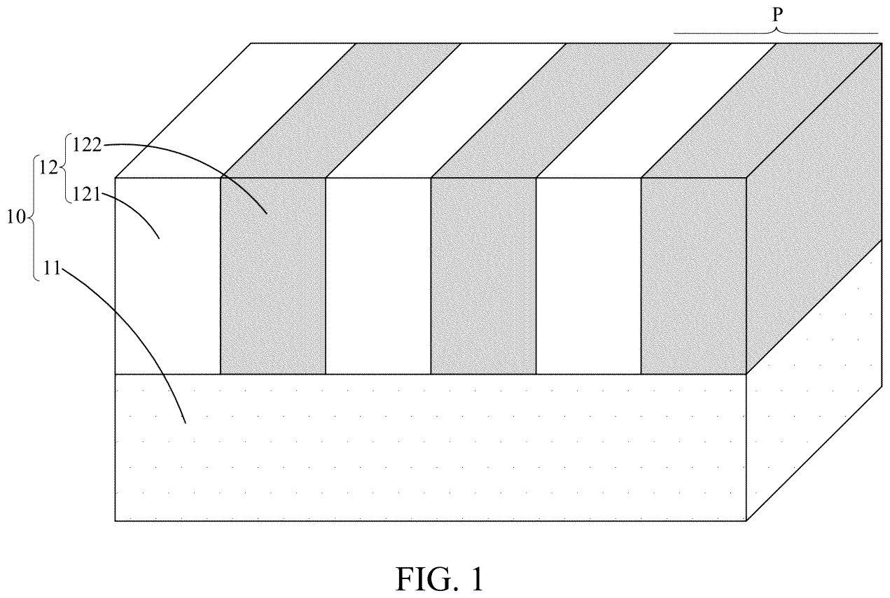

Referring to FIG. 1, the present disclosure relates to a polarizer. The polarizer includes a first polarization layer group 10. The first polarization layer group 10 includes a first light-transmitting layer 11 and a second light-transmitting layer 12.

Referring to FIG. 1, the first light-transmitting layer 11 has a first X-direction refractive index n_{TM1} and a first Y-direction refractive index n_{TE1}. In some embodiments, the production material of the first light-transmitting layer 11 is selected from a group composed of dielectric materials, glass, silicon, a cyclic olefin copolymer (COC), a cyclic olefin polymer (COP), polycarbonate (PC), polyethylene terephthalate (PET), polyimide (PI), polyether sulfone (PES), polyethylene naphthalate (PEN), triacetate cellulose (TAC), and polymethyl methacrylate (PMMA). An X-direction refractive index is a refractive index in a transverse magnetic (TM) wave direction, and a Y-direction refractive index is a refractive index in a transverse electric (TE) wave direction. Since the first light-transmitting layer 11 is made of a homogeneous material, the first X-direction refractive index n_{TM1} is the same as the first Y-direction refractive index n_{TE1}.

Referring to FIG. 1, the second light-transmitting layer 12 is superimposed on a top surface of the first light-transmitting layer 11, and the second light-transmitting layer 12 has a first light-transmitting medium 121 and a second light-transmitting medium 122 arranged transversely. As shown in the figure, multiple first light-transmitting medium 121 and second light-transmitting medium 122 are provided, so each first light-transmitting medium 121 and each second light-transmitting medium 122 are staggered closely to form the second light-transmitting layer 12. The first light-transmitting medium 121 has a third refractive index n3. The second light-transmitting medium 122 has a fourth refractive index n4. The third refractive index n3 is different from the fourth refractive index n4. The second light-transmitting layer 12 has a second X-direction refractive index n_{TM2} and a second Y-direction refractive index n_{TE2}. The first Y-direction refractive index n_{TE1} is different from the second Y-direction refractive index n_{TE2}. The first X-direction refractive index n_{TM1} is essentially the same as the second X-direction refractive index n_{TM2}.

Since the second light-transmitting layer 12 has the first light-transmitting medium 121 and the second light-transmitting medium 122 arranged in parallel, the second X-direction refractive index n_{TM2} and the second Y-direction refractive index n_{TE2} of the second light-transmitting layer 12 are equivalent refractive indices of the first light-transmitting medium 121 and the second light-transmitting medium 122. The calculation formula of the second X-direction refractive index n_{TM2} is shown in Formula 1. The calculation formula of the second Y-direction refractive index n_{TE2} is shown in Formula 2. The total length of the first light-transmitting medium 121 and the second light-transmitting medium 122 adjacent to the first light-transmitting layer 11 is determined as a structural period P. The ratio of the length of the first light-transmitting medium 121 adjacent to the second light-transmitting layer 12 to the structural period P is a proportion f. It can be known from Formula 1 and Formula 2 that after the materials of the first light-transmitting medium 121 and the second light-transmitting medium 122 are fixed, the second X-direction refractive index n_{TM2} and the second Y-direction refractive index n_{TE2} can be adjusted by adjusting the proportion of the first light-transmitting medium 121, so that the first Y-direction refractive index n_{TE1} is different from the second Y-direction refractive index n_{TE2}, and the first X-direction refractive index n_{TM1} is essentially the same as the second X-direction refractive index n_{TM2}. Or, the proportion of the first light-transmitting medium 121 is fixed, and then, the second X-direction refractive index n_{TM2} and the second Y-direction refractive index n_{TE2} can be adjusted by adjusting the materials of the first light-transmitting medium 121 and the second light-transmitting medium 122.

$${n}_{TM 2}^{2} = \frac{{( {n}_{1} {n}_{2} )}^{2}}{f * {n}_{2}^{2} + ( 1 - f ) * {n}_{1}^{2}} \qquad Formula 1$$

$${n}_{TE 2}^{2} = f * {n}_{1}^{2} + ( 1 - f ) * {n}_{2}^{2} \qquad Formula 2$$

As mentioned above, when the wavelength of the incident light is much greater than the structural period P, the polarizer has relatively equivalent refractive indices in X and Y directions, so as to construct an equivalent birefringent material, so that the present disclosure has the following advantages: (1) The absorption of light by metals can be reduced. (2) Due to different refractive indices in X and Y directions, when multiple first polarization layer groups 10 are stacked mutually, the number of stack layers can be effectively reduced to reduce the overall thickness. (3) The extinction ratio is comparable to that of a metal wire grid polarizer and superior to that of a multi-layer film polarizer.

In some embodiments, as shown in Formula 3, in a case that an incident angle is 0°, a product of a quadruple thickness h₁ of the first light-transmitting layer 11 and the first Y-direction refractive index n_{TE1} meets a wavelength of incident light; and as shown in Formula 4, a product of a quadruple thickness h₂ of the second light-transmitting layer 12 and the second Y-direction refractive index n_{TE2} meets the wavelength of incident light. Here, m represents any integer, such as 1, 2, 3, . . . , λ₀ represents a wavelength of incident light, n_{TE2} represents a second Y-direction refractive index n_{TE2}, and n_{TE1} represents a first Y-direction refractive index n_{TE1}.

$${h}_{1} = m * \frac{{λ}_{0}}{4 {n}_{TE 1}} \qquad Formula 3$$

$${h}_{2} = m * \frac{{λ}_{0}}{4 {n}_{TE 2}} \qquad Formula 4$$

In some embodiments, the first light-transmitting medium 121 and the second light-transmitting medium 122 are respectively made of dielectric materials. The dielectric materials include, but are not limited to, silicon dioxide (SiO₂), tantalum pentoxide (Ti₂O₅), titanium dioxide (TiO₂), silicon (Si), gallium nitride (GaN), gallium phosphide (GaP), and gallium arsenide (GaAs). In addition, one of the first light-transmitting medium 121 and the second light-transmitting medium 122 may be air.

In some embodiments, the first light-transmitting layer 11 has a fifth refractive index n5, and the fifth refractive index n5 is essentially the same as the third refractive index n3 or the fourth refractive index n4, that is, the fifth refractive index n5=the third refractive index n3≠the fourth refractive index n4, or the fifth refractive index n5=the fourth refractive index n4≠the third refractive index n3. In some embodiments, the third refractive index n3, the fourth refractive index n4, and the fifth refractive index n5 are different, and the third refractive index n3>the fifth refractive index n5>the fourth refractive index n4, or the fourth refractive index n4>the fifth refractive index n5>the third refractive index n3.

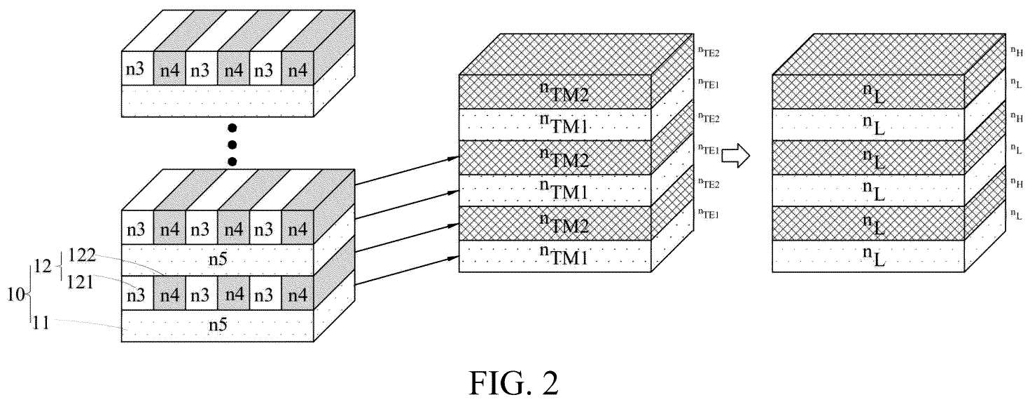

Referring to FIG. 2, during an actual implementation of the present disclosure, multiple same first polarization layer groups 10 are stacked layer by layer, the first X-direction refractive index n_{TM1} and the first Y-direction refractive index n_{TE1} of the first light-transmitting layer 11 are the same and are both the fifth refractive index n5, and the first light-transmitting medium 121 and the second light-transmitting medium 122 of the second light-transmitting layer 12 are equivalent to the second X-direction refractive index n_{TM2} and the second Y-direction refractive index n_{TE2}. In order to construct the equivalent birefringent material as a whole, it is necessary to adjust the proportion f, so that the first X-direction refractive index n_{TM1} is the same as the second X-direction refractive index n_{TM2}, and the first Y-direction refractive index n_{TE1} is different from the second Y-direction refractive index n_{TM2}. In order to further highlight the difference in refractive index, the first X-direction refractive index n_{TM1}, the first Y-direction refractive index n_{TE1}, and the second X-direction refractive index n_{TM2} are all the same and thus are set as a sixth refractive index n_{L}, and the second Y-direction refractive index n_{TE2} is set as a seventh refractive index n_{H}. In this way, as shown in FIG. 2, it is clear that the refractive indices of the polarizer in the X direction are all the same, while the refractive indices in the Y direction present a state of alternating two refractive indices, and the thicknesses of each first light-transmitting layer 11 and each second light-transmitting layer 12 in the Y direction meet a quarter of the wavelength of incident light.

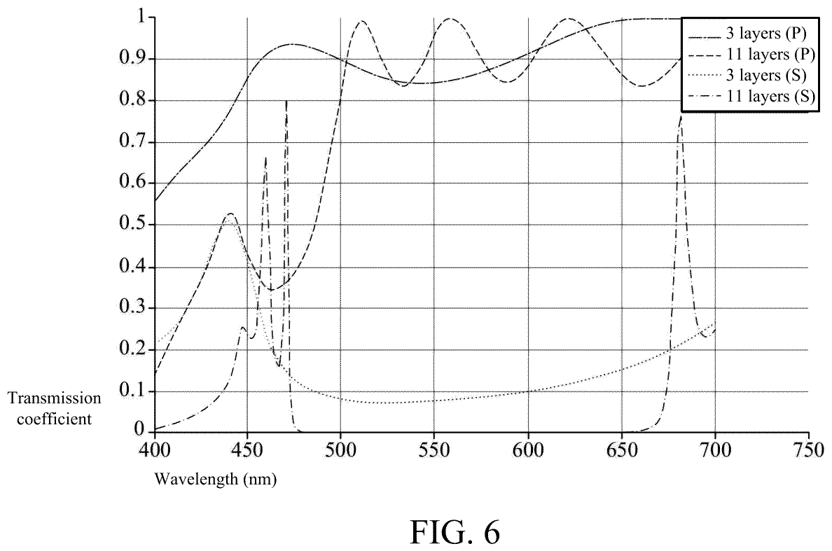

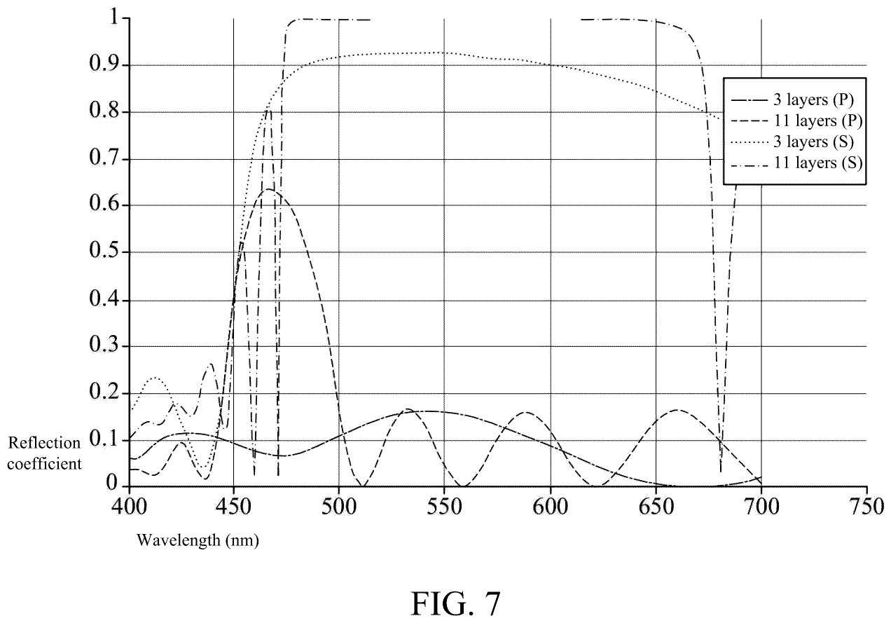

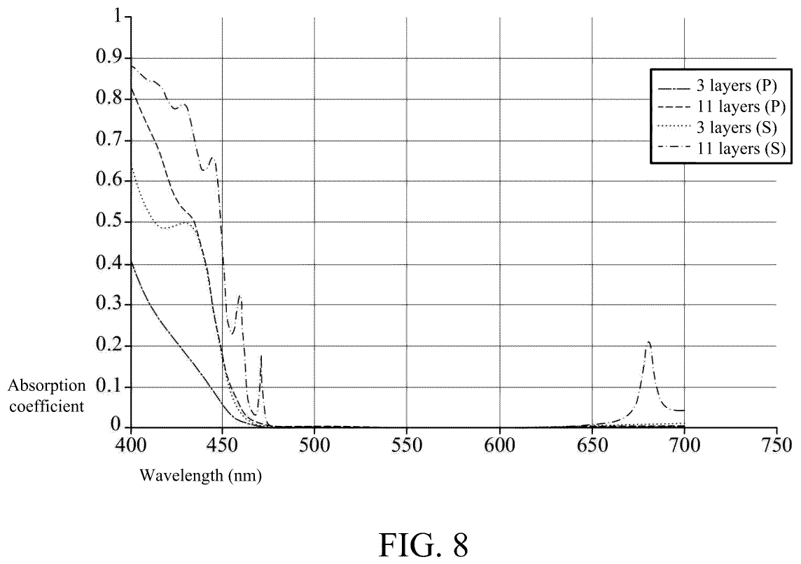

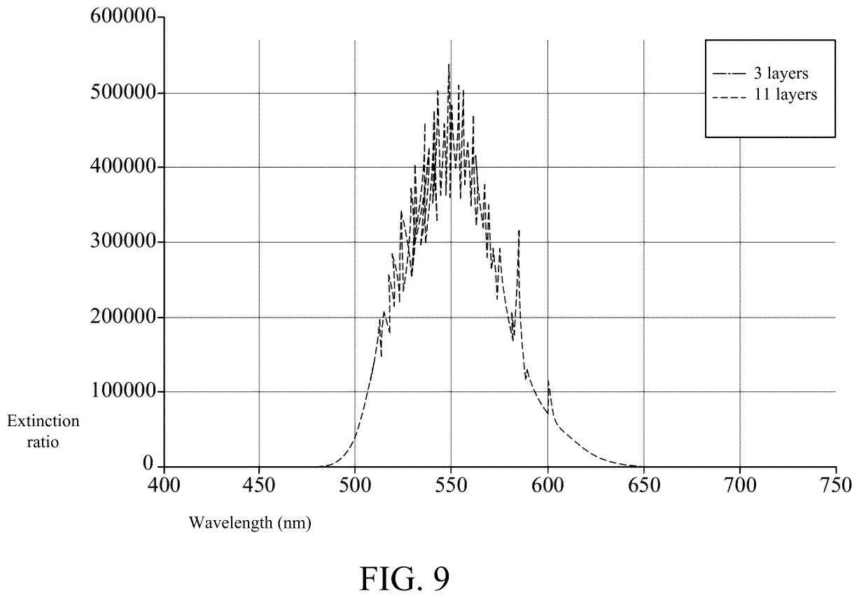

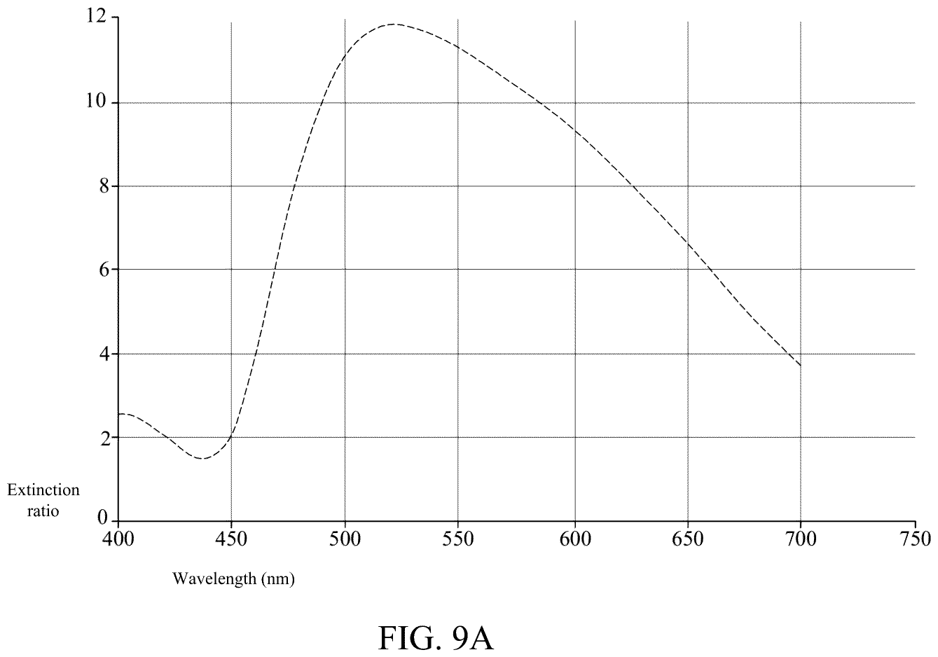

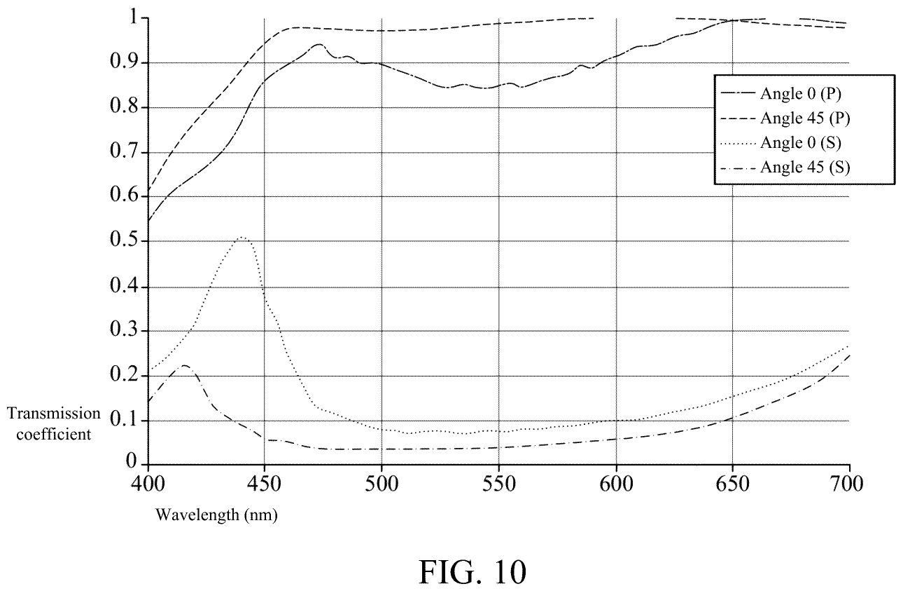

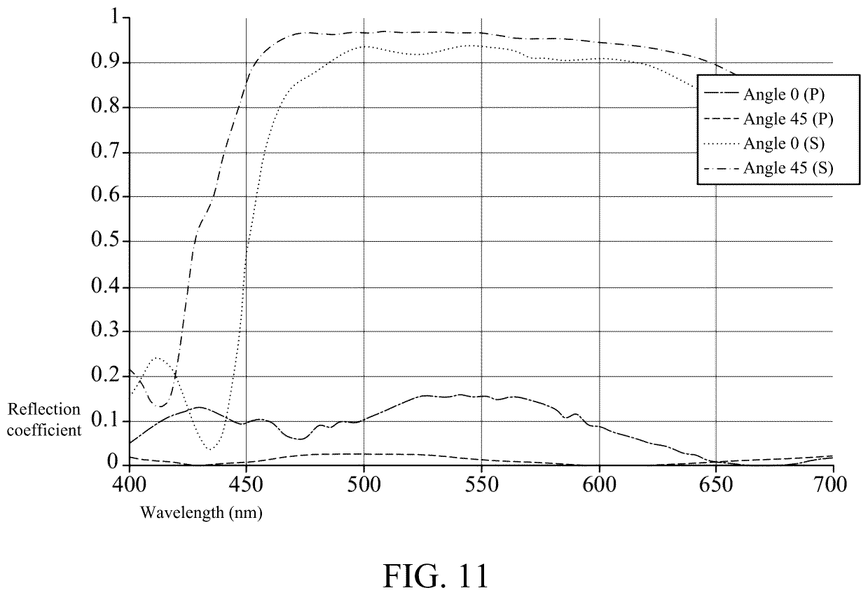

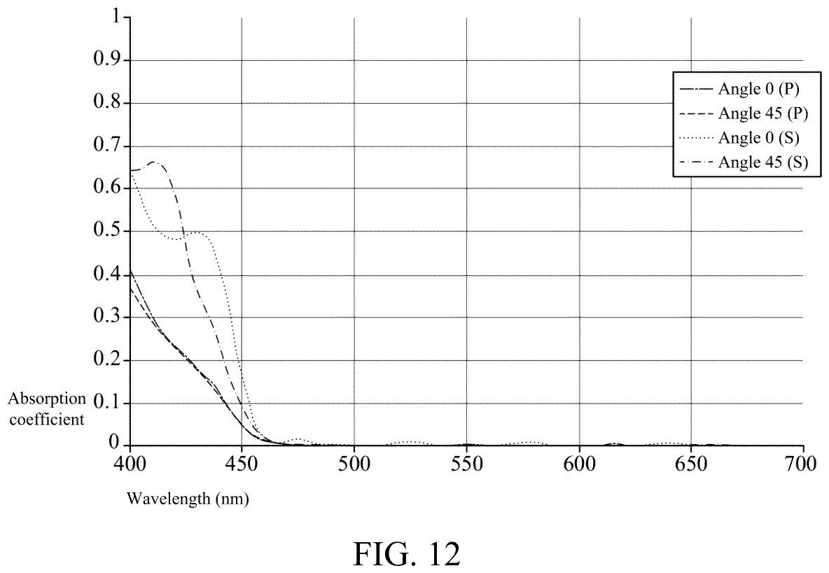

Referring to FIG. 1, in some embodiments, the material of the first light-transmitting layer 11 is PMMA, the material of the first light-transmitting medium 121 is GaP, the material of the second light-transmitting medium 122 is air, the structural period is 100 nm, and the proportion f is 0.6. Assuming that the central wavelength of incident light is 550 nm, the second X-direction refractive index n_{TM2} is about 1.4901, and the second Y-direction refractive index n_{TE2} is about 2.7476. According to Formula 3 and Formula 4, it can be known that the thickness of the first light-transmitting layer 11 is about 92 nm, and the thickness of the second light-transmitting layer 12 is about 50 nm. FIG. 6 shows an experimental data diagram of transmission coefficients of a TM wave and a TE wave after 3 first polarization layer groups 10 are stacked mutually and 11 first polarization layer groups are stacked mutually in this embodiment. It can be known from FIG. 6 that in a case that incident light is visible light, the transmission coefficient of the TE wave is significantly higher than the transmission coefficient of the TM wave. FIG. 7 shows an experimental data diagram of reflection coefficients of a TM wave and a TE wave after 3 first polarization layer groups 10 are stacked mutually and 11 first polarization layer groups 10 are stacked mutually in this embodiment. It can be known from FIG. 7 that in a case that incident light is visible light, the reflection coefficients of the TM wave is significantly higher than the reflection coefficient of the TE wave. FIG. 8 shows an experimental data diagram of absorption coefficients of a TM wave and a TE wave after 3 first polarization layer groups 10 are stacked mutually and 11 first polarization layer groups 10 are stacked mutually in this embodiment. It can be known from FIG. 8 that in a case that incident light is visible light, the absorption coefficients of the TE wave and the TM wave are almost 0. FIG. 9 shows an experimental data diagram of extinction ratios of incident light after 3 first polarization layer groups 10 are stacked mutually and 11 first polarization layer groups 10 are stacked mutually in this embodiment. Due to proportions of the experimental data diagram of extinction ratios of incident light after 3 first polarization layer groups 10 are stacked mutually in FIG. 9, the experimental data diagram of 3 first polarization layer groups 10 in FIG. 9 is quite close to an X axis. This part is shown in FIG. 9A, and an experimental data diagram of 3 first polarization layer groups 10 is displayed in different proportions. It can be known from FIG. 9 and FIG. 9A that the larger the number of layers of the first polarization layer groups 10, the better the extinction ratio of incident light. In addition, FIG. 10 to FIG. 12 show experimental data diagrams after 3 first polarization layer groups are stacked mutually. FIG. 10 shows an experimental data diagram of transmission coefficients of a TE wave and a TM wave at incident angles of 0° and 45°; FIG. 11 shows an experimental data diagram of reflection coefficients of a TE wave and a TM wave at incident angles of 0° and 45°; and FIG. 12 shows an experimental data diagram of absorption coefficients of a TE wave and a TM wave at incident angles of 0° and 45°. From this figure, it can be known that the absorption coefficient of the polarizer in a visible light band is almost 0. The extinction ratio refers to a ratio of the transmission coefficient of the TE wave to the transmission coefficient of the TM wave, that is, extinction

$$ratio = \frac{{T}_{TM}}{{T}_{TE}} .$$

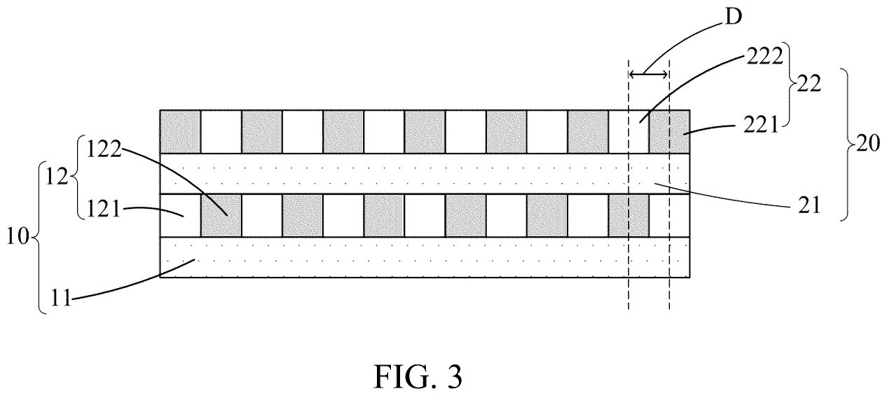

In some embodiments, multiple same first polarization layer groups 10 are perpendicularly stacked mutually. After stacking, the first light-transmitting medium 121 of each first polarization layer group 10 is located at the same horizontal position, and the second light-transmitting medium 122 of each first polarization layer group 10 is also located at the same horizontal position. Referring to FIG. 3, in some embodiments, a top surface of the first polarization layer group 10 is further provided with a second polarization layer group 20, the first polarization layer group 10 and the second polarization layer group 20 have a same structure, that is, the second polarization layer group 20 also includes a first light-transmitting layer 21 and a second light-transmitting layer 22, and the second light-transmitting layer 22 includes a first light-transmitting medium 221 and a second light-transmitting medium 222. A distance D between a horizontal position of the first light-transmitting medium 121 of the first polarization layer group 10 and a horizontal position of the first light-transmitting medium 221 of the second polarization layer group 20 is less than the structural period P. In this embodiment, at least one of the first light-transmitting medium 121 and the second light-transmitting medium 122 is rectangular. In the figure, both the first light-transmitting medium 121 and the second light-transmitting medium 122 are rectangular, the structural period P is less than 200 nm, and the thicknesses of both the first light-transmitting layer 11 and the second light-transmitting layer 12 meet a quarter of wavelength. It can be known from FIG. 3 that this manner causes the structure of the polarizer to form a staggered arrangement effect, and the staggered arrangement effect does not affect the optical effects (that is, the transmission coefficient, the reflection coefficient, the extinction ratio, and the absorption coefficient) of the polarizer. In addition, this embodiment may also be further implemented as follows: the refractive index of the first light-transmitting layer 11 is the same as the refractive index of one of the first light-transmitting medium 121 and the second light-transmitting medium 122, or the refractive indices of the first light-transmitting layer 11, the first light-transmitting medium 121, and the second light-transmitting medium 122 are different.

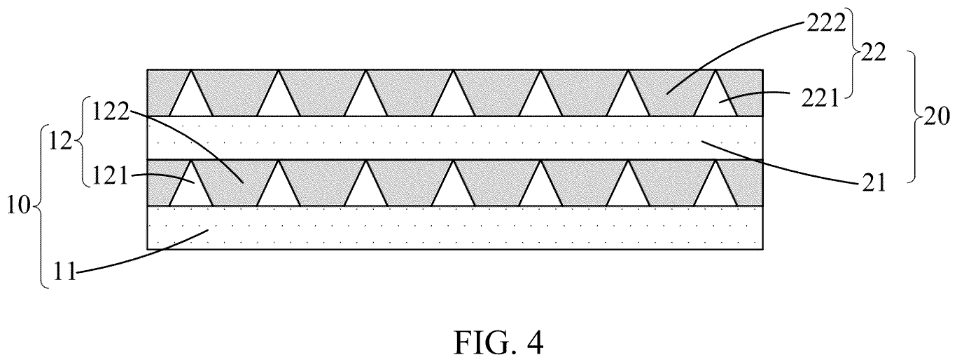

Referring to FIG. 4, in some embodiments, the cross-sectional view of one of the first light-transmitting medium 121 and the second light-transmitting medium 122 is a triangle to form a triangular structure. In FIG. 4, both the first light-transmitting medium 121 and the second light-transmitting medium 122 have triangular structures. In this embodiment, the thicknesses of both the first light-transmitting layer 11 and the second light-transmitting layer 12 meet a quarter of wavelength, and the overall structural period P is less than 200 nm. In addition, in some embodiments, a distance D between a horizontal position of the first light-transmitting medium 121 of the first polarization layer group 10 and a horizontal position of the first light-transmitting medium 221 of the second polarization layer group 20 is less than the structural period P. This manner causes the structure of the polarizer to form a staggered arrangement effect, and the staggered arrangement effect does not affect the optical effects (that is, the transmission coefficient, the reflection coefficient, the extinction ratio, and the absorption coefficient) of the polarizer. In addition, this embodiment may also be further implemented as follows: the refractive index of the first light-transmitting layer 11 is the same as the refractive index of one of the first light-transmitting medium 121 and the second light-transmitting medium 122, or the refractive indices of the first light-transmitting layer 11, the first light-transmitting medium 121, and the second light-transmitting medium 122 are different.

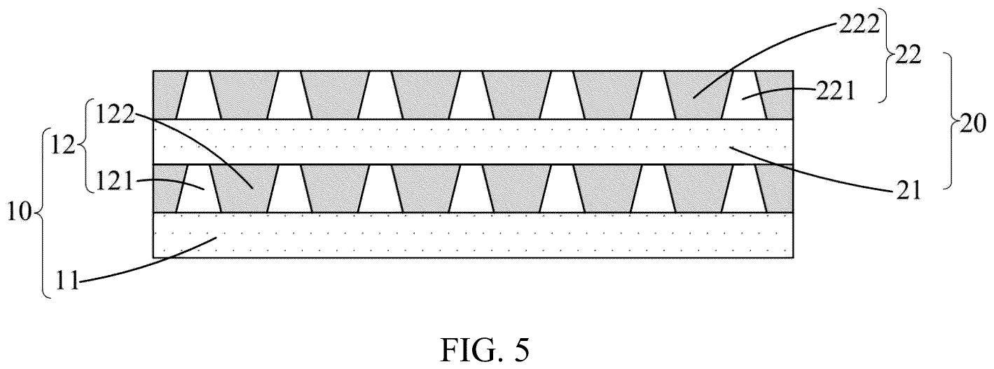

Referring to FIG. 5, in some embodiments, the cross-sectional view of one of the first light-transmitting medium 121 and the second light-transmitting medium 122 is a trapezoid to form a trapezoidal structure. In FIG. 5, both the first light-transmitting medium 121 and the second light-transmitting medium 122 have trapezoidal structures. In this embodiment, the thicknesses of both the first light-transmitting layer 11 and the second light-transmitting layer 12 meet a quarter of wavelength, and the overall structural period P is less than 200 nm. In addition, in some embodiments, a distance D between a horizontal position of the first light-transmitting medium 121 of the first polarization layer group 10 and a horizontal position of the first light-transmitting medium 221 of the second polarization layer group 20 is less than the structural period P. This manner causes the structure of the polarizer to form a staggered arrangement effect, and the staggered arrangement effect does not affect the optical effects (that is, the transmission coefficient, the reflection coefficient, the extinction ratio, and the absorption coefficient) of the polarizer. In addition, this embodiment may also be further implemented as follows: the refractive index of the first light-transmitting layer 11 is the same as the refractive index of one of the first light-transmitting medium 121 and the second light-transmitting medium 122, or the refractive indices of the first light-transmitting layer 11, the first light-transmitting medium 121, and the second light-transmitting medium 122 are different.

In addition, although the above embodiment presents the first polarization layer group 10 and the second polarization layer group 20, the structures of the first light-transmitting medium 121 and 221 or the second light-transmitting medium 122 and 222 of both are all the same, and are either trapezoidal, rectangular, or triangular. However, the arrangement manner of the present disclosure is not limited to this. One of the first light-transmitting medium 121 and the second light-transmitting medium 122 of the first polarization layer group 10 may be trapezoidal, and one of the first light-transmitting medium 221 and the second light-transmitting medium 222 of the second polarization layer group 20 may be rectangular. Thus, the structures of the first light-transmitting medium 121 and the second light-transmitting medium 122 of the first polarization layer group 10 are different from the structures of the first light-transmitting medium 221 and the second light-transmitting medium 222 of the second polarization layer group 20. In addition, when three or more polarization layer groups are provided, the structures of three polarization layer groups may be in trapezoidal, rectangular, and triangular arrangement combination.

In some embodiments, the present disclosure provides a display, the display includes a display body, and the above polarizer is arranged in the display body. Relevant embodiments of the polarizer can be referred to the above descriptions and will not be repeated here.

Of course, many other embodiments of the present disclosure may be provided. Without departing from the spirit and essence of the present disclosure, those skilled in the art can make various corresponding changes and deformations according to the present disclosure, but these corresponding changes and deformations should fall within the protection scope of the claims of the present disclosure.

What is claimed is:

1. A polarizer, comprising:
a first polarization layer group, comprising:
a first light-transmitting layer, having a first X-direction refractive index and a first Y-direction refractive index, and
a second light-transmitting layer, superimposed on a top surface of the first light-transmitting layer, and the second light-transmitting layer having a second X-direction refractive index and a second Y-direction refractive index, wherein the first Y-direction refractive index is different from the second Y-direction refractive index, and the first X-direction refractive index is essentially the same as the second X-direction refractive index; and the second light-transmitting layer has a first light-transmitting medium and a second light-transmitting medium arranged transversely, and a third refractive index of the first light-transmitting medium is different from a fourth refractive index of the second light-transmitting medium.

2. The polarizer according to claim 1, wherein in a case that an incident angle is 0°, a product of a quadruple thickness of the first light-transmitting layer and the first Y-direction refractive index meets a wavelength of incident light; and a product of a quadruple thickness of the second light-transmitting layer and the second Y-direction refractive index meets the wavelength of incident light.

3. The polarizer according to claim 2, wherein the first light-transmitting medium and the second light-transmitting medium together have a structural period; and a top surface of the first polarization layer group is further provided with a second polarization layer group, the first polarization layer group and the second polarization layer group have a same structure, and a distance between a horizontal position of the first light-transmitting medium of the first polarization layer group and a horizontal position of the first light-transmitting medium of the second polarization layer group is less than the structural period.

4. The polarizer according to claim 3, wherein a fifth refractive index of the first light-transmitting layer is essentially the same as the third refractive index or the fourth refractive index.

5. The polarizer according to claim 4, wherein the first light-transmitting medium has a proportion in the structural period, and the second X-direction refractive index and the second Y-direction refractive index are determined according to the proportion, the third refractive index, and the fourth refractive index.

6. The polarizer according to claim 1, wherein the first light-transmitting medium and the second light-transmitting medium together have the structural period, and the structural period is much less than the wavelength of incident light.

7. The polarizer according to claim 6, wherein the first light-transmitting medium and the second light-transmitting medium are respectively made of dielectric materials; and the production material of the first light-transmitting layer is selected from a group composed of dielectric materials, glass, silicon, a cyclic olefin copolymer (COC), a cyclic olefin polymer (COP), polycarbonate (PC), polyethylene terephthalate (PET), polyimide (PI), polyether sulfone (PES), polyethylene naphthalate (PEN), triacetate cellulose (TAC), and polymethyl methacrylate (PMMA).

8. The polarizer according to claim 6, wherein a cross-sectional view of these first light-transmitting medium is triangular.

9. The polarizer according to claim 6, wherein a cross-sectional view of these first light-transmitting medium is trapezoidal.

10. The polarizer according to claim 6, wherein a cross-sectional view of these first light-transmitting medium is rectangular.

11. A display, comprising:
a display body, and
a polarizer, arranged in the display body, and the polarizer comprising:
a first polarization layer group, comprising:
a first light-transmitting layer, having a first X-direction refractive index and a first Y-direction refractive index, and
a second light-transmitting layer, superimposed on a top surface of the first light-transmitting layer, and the second light-transmitting layer having a second X-direction refractive index and a second Y-direction refractive index, wherein the first Y-direction refractive index is different from the second Y-direction refractive index, and the first X-direction refractive index is essentially the same as the second X-direction refractive index; and the second light-transmitting layer has a first light-transmitting medium and a second light-transmitting medium arranged transversely, and a third refractive index of the first light-transmitting medium is different from a fourth refractive index of the second light-transmitting medium.

12. The display according to claim 11, wherein in a case that an incident angle is 0°, a product of a quadruple thickness of the first light-transmitting layer and the first Y-direction refractive index meets a wavelength of incident light; and a product of a quadruple thickness of the second light-transmitting layer and the second Y-direction refractive index meets the wavelength of incident light.

13. The display according to claim 12, wherein the first light-transmitting medium and the second light-transmitting medium together have a structural period; and a top surface of the first polarization layer group is further provided with a same second polarization layer group, and a distance between a horizontal position of the first light-transmitting medium of the first polarization layer group and a horizontal position of the first light-transmitting medium of the second polarization layer group is less than the structural period.

14. The display according to claim 13, wherein a fifth refractive index of the first light-transmitting layer is essentially the same as the third refractive index or the fourth refractive index.

15. The display according to claim 14, wherein the first light-transmitting medium has a proportion in the structural period, and the second X-direction refractive index and the second Y-direction refractive index are determined according to the proportion, the third refractive index, and the fourth refractive index.

16. The display according to claim 11, wherein the first light-transmitting medium and the second light-transmitting medium together have the structural period, and the structural period is much less than the wavelength of incident light.
